(19) United States
(12) Patent Application Publication
(10) Pub. No.: US 2004/0044959 A1
(43) Pub. Date: Mar. 4, 2004

(54) System, method, and computer program product for querying XML documents using a relational database system

(76) Inventors: Jayavel Shanmugasundaram, Ithaca, NY (US); Eugene Jon Shekita, San Jose, CA (US)

Correspondence Address: MARK D. MCSWAIN, IBM ALMADEN RESEARCH CENTER, IP LAW DEPT., 650 HARRY ROAD, CHTA/J2B, SAN JOSE, CA, 95120, US

(21) Appl. No.: 10/234,876

(22) Filed: Aug. 30, 2002

(51) Int. Cl. G06F 17/00

(52) U.S. Cl. 715/513

(57) ABSTRACT

A technique enabling querying of XML documents in a relational database system via a reconstruction view allowing XML documents to be queried as though XML views of relational data. A single query processor can be used with all relational schema generation methods (whether or not using XML schema information) to seamlessly query across XML documents, relational data, and XML views of relational data; no special purpose query processor is required. The technique creates an XML document view, creates relational tables for storing XML documents using relational schema, shreds the XML documents and stores the XML documents as rows in the relational tables according to the relational schema, generates a reconstruction view over the relational tables to define how the shredded documents are to be virtually reconstructed, and processes queries over the stored XML documents as queries over the reconstruction view.

### CROSS-REFERENCE TO RELATED APPLICATIONS

This application is related to commonly-owned U.S. Ser. No. 09/531,802, “Using an XML Query Language to Publish Relational Data as XML”, filed on Mar. 21, 2000, which is hereby incorporated by reference.

### FIELD OF THE INVENTION

This invention relates to database systems and querying seamlessly across existing relational data, XML documents, and XML views of relational data using the same query processor.

### BACKGROUND OF THE INVENTION

XML has emerged as the dominant standard for data representation and exchange over the Internet. Its nested, self-describing structure provides a simple yet flexible means for applications to model and exchange data. For example, a business can easily model complex structures such as purchase orders in XML form and send them for further processing to its business partners. As another example, all of Shakespeare's plays can be marked up and stored as XML documents so that information such as the beginning of a new section, or the names of the speakers, can be semantically captured as XML tags. In fact, there are already many industry proposals to standardize XML document structures for domains as diverse as electronic commerce and real estate. See for example World Wide Web Consortium, “Extensible Markup Language (XML) 1.0 (Second Edition),” W3C Recommendation, October 2000, available at www.w3c.org/TR/REC-xml.

With a large amount of data represented as XML documents, it becomes necessary to store and query these XML documents. For example, a business that receives XML purchase orders may need to store these purchase orders, and later query them to see which items need to be shipped. Similarly, once all Shakespeare's plays are represented as XML documents, it becomes necessary to store these documents, and query them to find answers to questions such as: who said “to be or not to be”.

There has been some work done on building native XML database systems to address the problem of storing and querying XML documents. See for example R. Goldman, et al., “From Semi-structured Data to XML: Migrating the Lore Data Model and Query Language,” Workshop on the Web and Databases, Philadelphia, Pa., June 1999 and J. Naughton et al., “The Niagara Internet Query System,” unpublished document available at www.cs.wisc.edu/niagara/Publications.html. These database systems are built from scratch for the specific purpose of storing and querying XML documents. While this is one approach to solving this problem, it has two potential disadvantages. First, native XML database systems do not harness the sophisticated storage and query capability already supported in existing relational database systems. Second, native XML database systems do not allow users to write XML queries that span XML documents and data stored in relational database systems.

There have been techniques proposed for storing and querying XML documents using relational database systems to overcome the first of the above limitations. See for example A. Deutsch, et al., “Storing Semi-structured Data with STORED,” Proceedings of the SIGMOD Conference, Philadelphia, Pa., May 1999. See also D. Florescu and D. Kossman, “Storing and Querying XML Data using an RDBMS,” IEEE Data Engineering Bulletin, 22(3), p. 27-34, 1999, hereby incorporated by reference and referred to as DF99 hereafter. See also J. Shanmugasundaram et al., “Relational Databases for Querying XML Documents: Limitations and Opportunities,” Proceedings of the VLDB Conference, Edinburgh, Scotland, September 1999, hereby incorporated by reference and referred to as JS99 hereafter. These approaches work as follows. The first step is relational schema generation, where relational tables are created for the purpose of storing XML documents. The next step is XML document shredding, where XML documents are stored by shredding them into rows of the tables that were created in the first step. The final step is XML query processing, where XML queries over the shredded XML documents are converted into SQL queries over tables. The SQL query results are then tagged to produce the desired XML result.

The wealth of literature in this field makes it clear that there are many possible approaches for relational schema generation. This is because the appropriate relational schema for a given application depends on many factors such as the nature of data, the query workload, and availability of XML schemas. Currently, each relational schema generation method has its own query processor for translating XML queries into SQL queries. There is no existing query processor that can provide a general query capability for all relational schema generation methods.

### SUMMARY OF THE INVENTION

It is accordingly an object of this invention to enable querying of XML documents in a relational database system wherein a single query processor is used with any relational schema generation method. This greatly simplifies the task of relational schema generation by eliminating the need to write a special-purpose query processor for each new solution to the problem. Further, we show that a query processor for querying XML views of existing relational data can be used. Therefore, the same query processor can be used to execute queries that span XML documents and XML views of relational data. We also show how it enables users to query seamlessly across XML documents and existing relational data. Further, we illustrate how this technique is applicable for two well known relational schema generation methods, one that employs XML Schema, and one that does not.

It is a related object of the invention to create an XML document view, create relational tables for storing XML documents using relational schema, shred the XML documents and store the XML documents as rows in the relational tables according to the relational schema, generate a reconstruction view over the relational tables to define how the shredded documents are to be virtually reconstructed, and processing queries over the stored XML documents as queries over the reconstruction view.

The foregoing objects are believed to be satisfied by the embodiments of the present invention as described below.

### BRIEF DESCRIPTION OF THE DRAWINGS

The foregoing objects are believed to be satisfied by the embodiments of the present invention as described below.

FIG. 1 is a diagram of the method for storing and querying XML documents according to a first embodiment of the present invention.

FIG. 2 is a diagram of an XML document view definition.

FIG. 3 is a diagram of a DTD (Document Type Definition) graph.

FIG. 4 is a diagram of a purchase order document and its shredding into tables with XML schema according to a first embodiment of the present invention.

FIG. 5 is a diagram of a default XML view for the relational schema according to a first embodiment of the present invention.

FIG. 6 is a diagram of a query that defines the reconstruction view according to a first embodiment of the present invention.

FIG. 7 is a diagram of the method steps for creating a reconstruction view given an arbitrary DTD graph with XML schema according to a first embodiment of the present invention.

FIG. 8 is a diagram of a purchase order document and its shredding into a table without XML schema according to a preferred embodiment of the present invention.

FIG. 9 is a diagram of a query that defines the reconstruction view according to the preferred embodiment of the present invention.

### DETAILED DESCRIPTION OF THE INVENTION

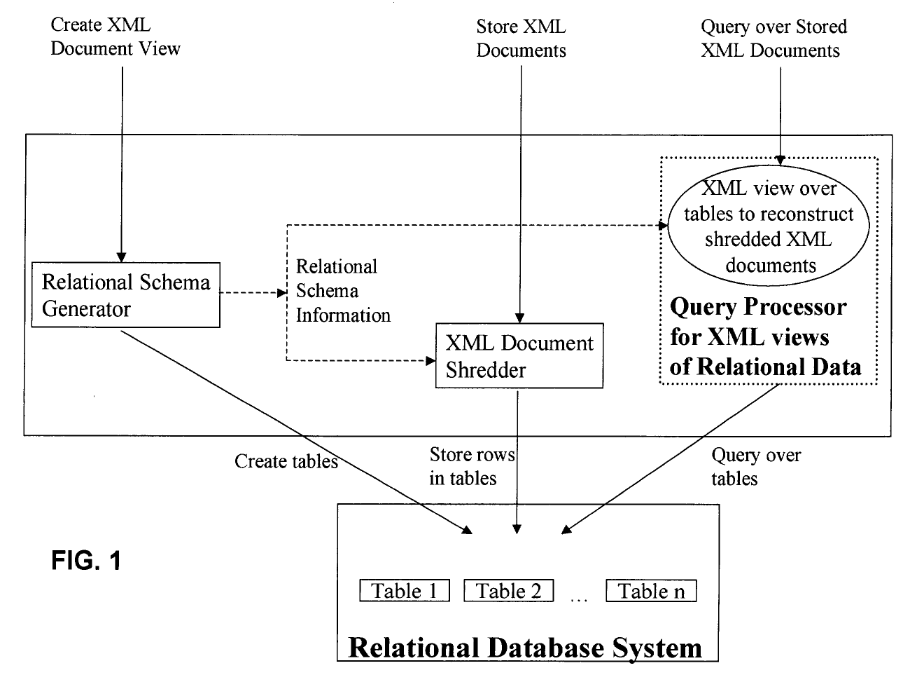

Referring now to FIG. 1, the technique for storing and querying XML documents of the present invention is shown. The first step of the technique is to create an XML document view. Once the XML document view is created, one of possibly many relational schema generation methods can be used to automatically create relational tables for storing XML documents. XML documents “stored” in this view are then shredded and stored as rows in these relational tables. In addition, a reconstruction view is created over the tables, which virtually reconstructs the XML documents from the shredded rows. The reconstruction view is specified just like a regular XML view of relational data. Queries over the stored XML documents are then treated as queries over the reconstruction view.

A reconstruction view makes it possible to treat an XML document view as though it is an XML view of relational data. As a result, a query over XML documents can be processed as a query over the reconstruction view, using a query processor that can execute queries over XML views of relational data. Thus, a single query processor is sufficient to support queries over XML documents, regardless of the relational schema generation method. Further, the same query processor can support queries over XML documents and XML views of existing relational data, since they are ultimately all just XML views of relational data. This makes it possible to seamlessly query over XML documents and XML views of relational data.

The proposed technique is general enough to support any relational schema generation method because, for a given method, only a program stub that does the following (possibly with the schema of the XML documents to be stored) is required:

1) Generate the desired relational schema for storing XML documents

2) Shred an input XML document into the tables of the generated relational schema

3) Create a reconstruction view over the relational schema that defines how shredded XML documents are reconstructed

The above steps assume the existence of a query processor that enables XML views over relational data to be defined (and queried) using an XML query language. Such a query processor is described in the 09/531,802 patent application and in M. Carey et al., “XPERANTO: Publishing Object-Relational Data as XML,” Workshop on the Web and Databases (Informal Proceedings), Dallas, Tex., May 2000, which is hereby incorporated by reference. It is important to note that (1) and (2) have to be performed regardless of whether the proposed technique is used. However, using the proposed technique, it is sufficient to just generate a reconstruction view (3) rather than write a full-blown XML query processor. The former is probably an order of magnitude easier to accomplish than the latter. As a result, the proposed technique eliminates the need to build a new query processor for different relational schema generation methods.

Two relational schema generation methods published in the literature are used as illustrative examples of how the reconstruction view is relatively easy to create; one uses XML schema information, and the other does not.

### Relational Schema Generation and XML Document Shredding Using XML Schema

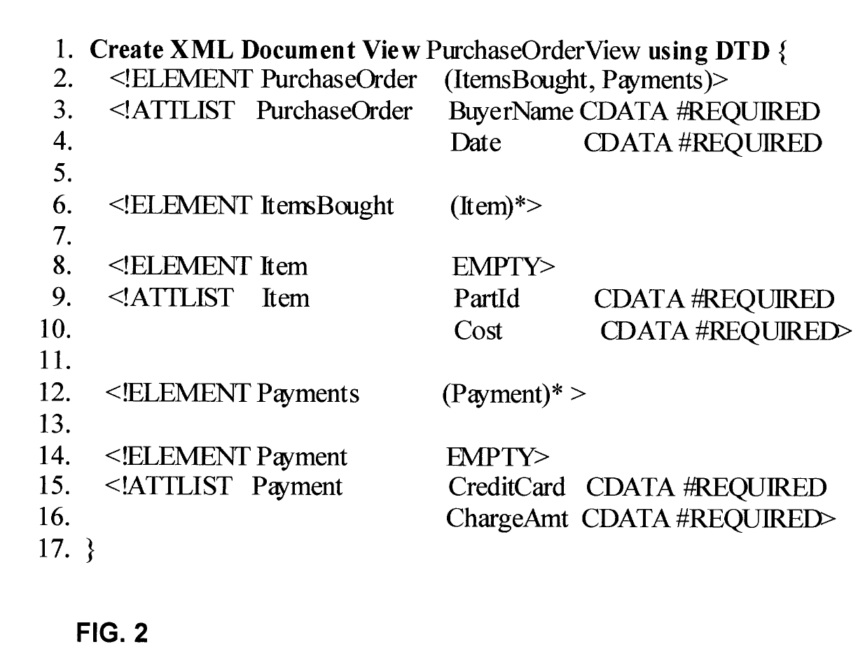

A reconstruction view can be created for the relational schema generation method proposed in JS99, which uses XML schema information (DTDs or Document Type Definitions) to create the appropriate tables. To illustrate how the JS99 method works, consider the XML document view definition shown in FIG. 2. The body of the view specifies the DTD of the XML documents to be stored. A description of the DTD specification is provided for readers unfamiliar with DTDs. The top-level element is called “PurchaseOrder” (lines 2-4). Each purchase order element has two sub-elements, namely “ItemsBought” and “Payments” (line 2). Each purchase order element also has two attributes—“BuyerName” and “Date” (lines 3-4). Each “Items” element has zero or more “Item” Elements (line 6), and each “Item” element in turn has two attributes (lines 9-10) but no sub-elements (line 8). “Payments” elements are defined similarly.

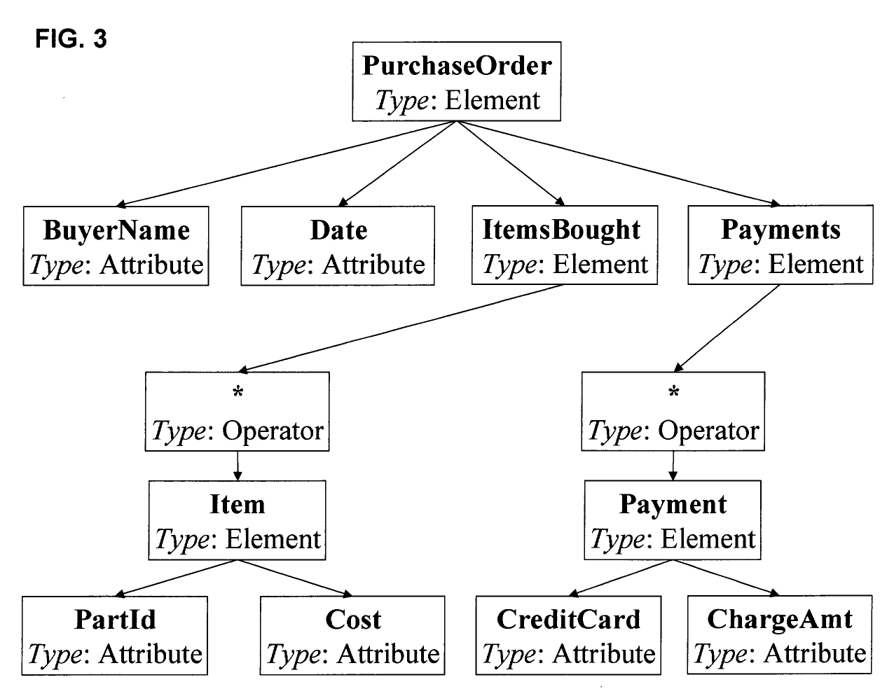

Given the DTD information of the XML documents to be stored, the relational schema generation method proposed in JS99 works as follows. First, a structure called the DTD graph that mirrors the structure of the DTD is created. The DTD graph for our example is shown in FIG. 3. As can be seen, each node in the graph represents an XML element, an XML attribute or an “operator”. The “*” operator is used to identify “set” sub-elements, i.e., those that can occur many times under a parent element.

After being created, the DTD graph is traversed to construct the desired relational schema. This is done by first creating a relation for the root element of the DTD graph (“PurchaseOrder” in our example). All children of an element are represented in the same relation as the element, except if the child is a “*” node. In the latter case, the child of the “*” node is represented in a separate relation since it corresponds to a “set” child and regular relations cannot capture set-valued attribute. As a result, separate relations are created for the “Item” and “Payment” elements.

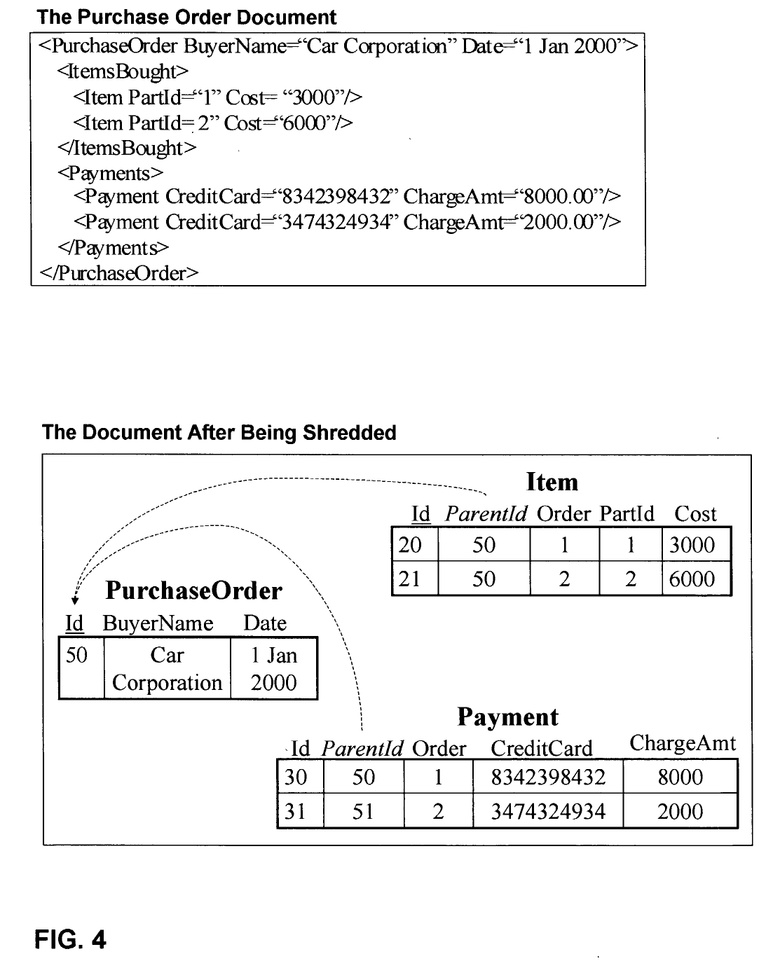

An example PurchaseOrder document and its shredding into tables is shown in FIG. 4. Note that all tables have an “Id” field, which serves as the primary key. In addition, all tables corresponding to non-root elements (“Item”, “Payment”) also have a “ParentId” field, which is a foreign key reference to its parent “PurchaseOrder”. This is to link a child element to its parent element. Each table corresponding to a non-root element also has an order field, which specifies the order in which the child elements appear under the parent element in the XML document.

We now show how a reconstruction view can be created for the relational schema generation method described above, according to a first embodiment of the present invention. Recall that a reconstruction view is used to reconstruct XML documents that have been shredded.

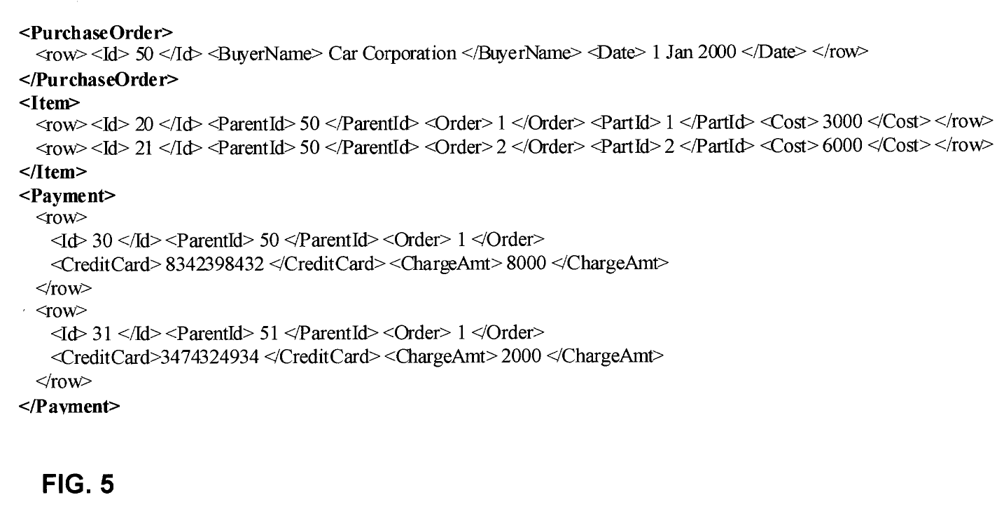

A reconstruction view is defined as an XML query over the default XML view. The default XML view provides a simple (virtual) mapping from tables to XML. The default XML view for the relational schema in our example is given in FIG. 5. As shown, each table is assigned a top-level element whose tag name is the same as the table name. A “row” element is generated for each row in a table. Sub-elements are allocated for each column in the row, with name tags that match their column name. Finally, a column's value appears within its sub-element.

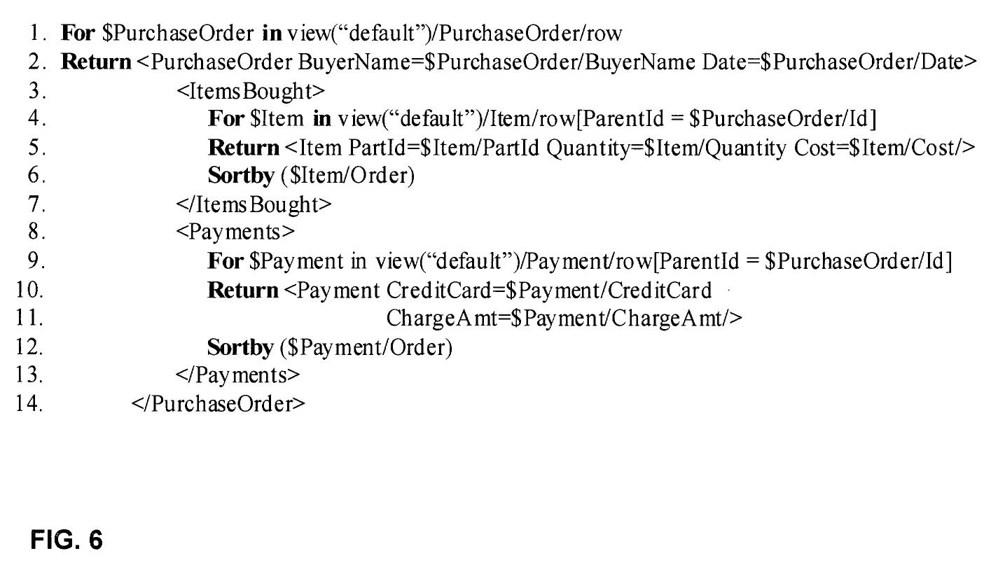

The query that defines the reconstruction view for our example is shown in FIG. 6. The query language used is XQuery. For more information on XQuery, see World Wide Web Consortium, “XQuery: A Query Language for XML,” W3C Working Draft, February 2000, available at www.w3c.org/TR/xquery. As shown, the query loops over all rows in the PurchaseOrder table to reconstruct the top-level “PurchaseOrder” XML elements. Nested queries are used to reconstruct “Item” and “Payment” sub-elements. Note that an orderby clause appears in the nested queries so that the sub-elements appear in the same order as they appeared in the original XML document.

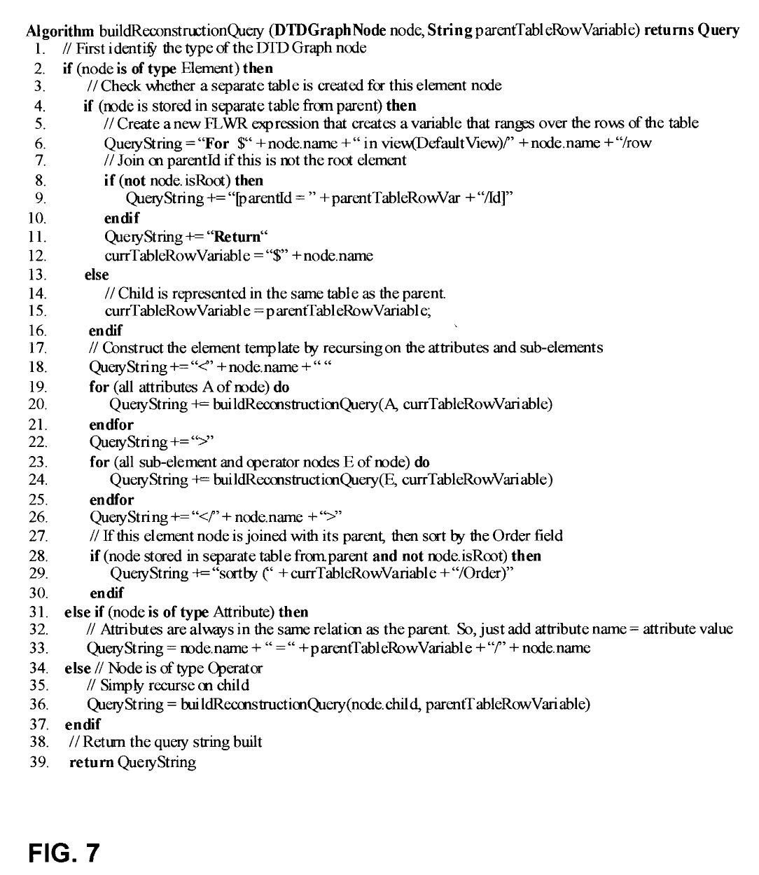

FIG. 7 presents the algorithm for creating a reconstruction view given an arbitrary DTD graph. The algorithm works by recursively traversing the DTD graph used for relational schema generation. We walk through the algorithm using the DTD graph in FIG. 3 and its corresponding reconstruction view in FIG. 6 as an example.

The algorithm is invoked with the root node of the DTD graph (PurchaseOrder in our example). Here, the root node has no parents so parentTableRowVariable is set to null. Since the PurchaseOrder node is of type “Element” and a new table has been created for this element, an XQuery “For” clause that binds the variable $PurchaseOrder to the rows of the PurchaseOrderTable is created (line 6, generating line 1 in FIG. 6). Then the PurchaseOrder XML element tag is created (line 18) and the algorithm is invoked recursively on the child attribute (lines 19-21), operator and sub-element (lines 23-25) nodes to create the XQuery fragments to reconstruct these nodes.

During the recursion, parentTableRowVariable is set to the value “$PurchaseOrder” so that children can refer to rows in the parent table. Constructing Quilt query fragments for attribute nodes (lines 31-33) simply assigns the attribute name to the appropriate attribute value using the parent table row variable because attributes are always represented in the same table as their parent elements. This generates the attribute construction fragments in lines 2, 6 and 12 in FIG. 6. Constructing XQuery fragments for operator nodes (lines 34-36) is achieved by simply recursing on the child of the operator node. Constructing XQuery fragments for sub-element nodes is similar to that of the root node, except that a join condition is needed to relate it to its parent (lines 8-10). Also, a sortby clause is needed to order the sub-elements in the same way as they appear in the original XML document (lines 28-30 in FIG. 7, generating lines 8 and 15 in FIG. 6). If a separate table has been created for a node in the relational schema, a new sub-query is generated. In our example, separate queries are created for PurchaseOrder, Item and Payment nodes. Nested queries are related to the parent query by joining on the parentId field.

### Relational Schema Generation and XML Document Shredding Without Using XML Schema

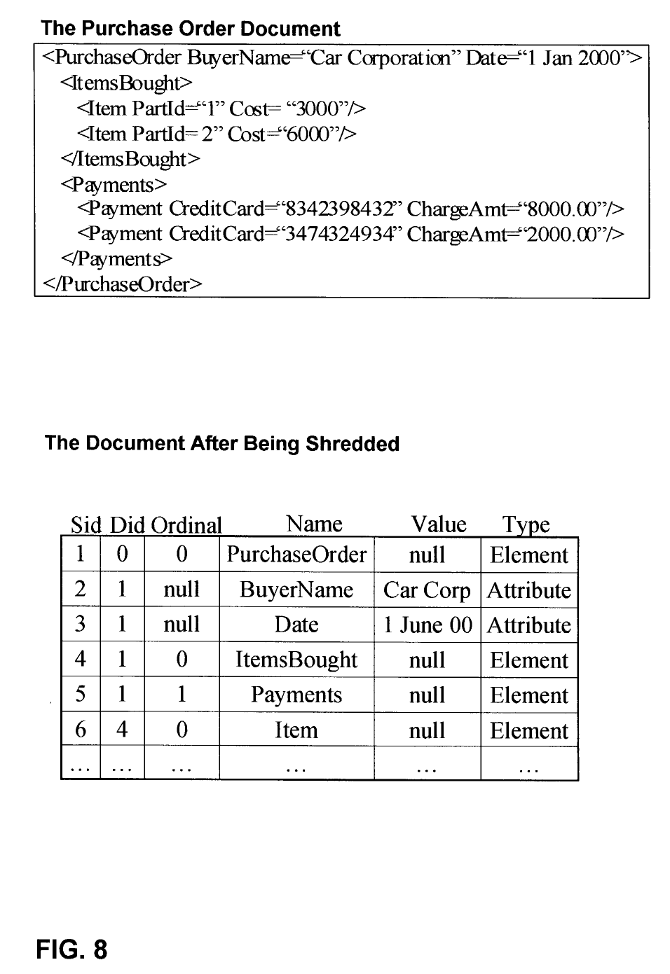

We now show how a reconstruction view can also be created for the relational schema generation method proposed in DF99, that does not make use of XML schema information (unlike the JS99 method). This technique is more general and represents the preferred embodiment of the present invention. The basic idea behind this relational schema generation method is to view an XML document as a graph. The nodes of the graph are XML elements and attributes, and the edges of the graph represent containment relationships. Each edge of this graph is then stored in a relational table called the Edge table. FIG. 8 shows the Edge table populated with the edges of our example XML document.

As FIG. 8 shows, each edge is uniquely identified by the ids of the source and destination nodes (the sid and did fields). Each edge also contains the name, value, and type information about its destination node. The order among sibling sub-elements is captured using the ordinal field. In our example, the edge pointing to the root XML element (“PurchaseOrder”) is mapped to the first row. Its sid field is 0, which represents the id of the document root.

Also note that the edges pointing to the BuyerName and Date attributes of the “PurchaseOrder” element are mapped to the second and third row, respectively. Note that these are related to the purchase order using the sid field. Similarly, the “ItemsBought” and “Payments” sub-elements of a “PurchaseOrder” element are represented by the fourth and fifth row respectively. The ordinal field captures their relative order. The other edges of the document are stored similarly.

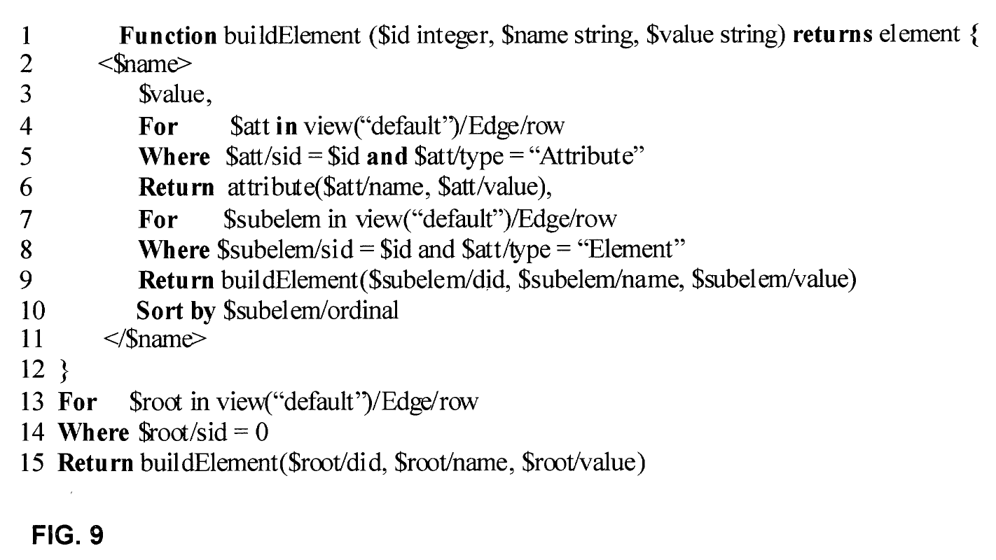

We now show the reconstruction view for the relational schema generation method described above. Once again, the reconstruction view is defined as an XML query over the default XML view. However, this time the same reconstruction view will work for any XML document format, regardless of the underlying DTD or XML Schema. FIG. 9 shows the query that defines the reconstruction view.

The query first determines the edge pointing to the root element and invokes a function called buildElement to construct the root element (lines 13-15). The buildElement function (lines 1-12) is recursive and builds up document fragments rooted at a given element. It first creates an element with the appropriate tags (line 2). It then produces the character values associated with an element (line 3). A nested sub-query is then used to determine the edges pointing to the attributes of the element (lines 4-6), and the attributes are then created using the XQuery built-in function attribute (line 6). Finally, another nested sub-query is used to determine the edges pointing to the sub-element of the element (lines 7-8), and these are then created by recursively invoking the buildElement function (line 9). The sub-elements are then ordered by their ordinal position (line 10).

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the invention has been described with respect to illustrative embodiments thereof, it will be understood that various changes may be made in the apparatus and means herein described without departing from the scope and teaching of the invention. Accordingly, the described embodiment is to be considered merely exemplary and the invention is not to be limited except as specified in the attached claims.

We claim:

1. A method for querying XML documents in a relational database system, comprising the steps of:
creating an XML document view;
creating relational tables for storing XML documents using relational schema;
shredding said XML documents and storing said XML documents as rows in said relational tables according to said relational schema;
generating a reconstruction view over said relational tables to define how said shredded XML documents are to be virtually reconstructed; and
processing queries over said stored XML documents as queries over said reconstruction view.

2. The method of claim 1 wherein said relational schema may be generated by any number of generation methods, including those methods using a DTD, those methods using XML Schema, those methods ignoring any DTD, and those methods ignoring any XML Schema.

3. The method of claim 1 wherein said processing step processes queries over at least one of said XML documents, relational data, XML views of said relational data.

4. The method of claim 1 wherein a DTD is provided, comprising the further steps of:
recursively traversing a DTD graph for relational schema generation;
binding variables to said rows using an XQuery “For” clause;
creating XML element tags;
recursively invoking the above steps on child attributes and operator nodes and sub-element nodes to create XQuery fragments to reconstruct said nodes.

5. The method of claim 4 comprising the further steps of:
relating said sub-element nodes to respective parent nodes by a join;
ordering said sub-element nodes in the same way as said sub-element nodes appear in said XML documents using a sortby clause.

6. The method of claim 1 wherein XML schema information is not used, comprising the further steps of:
determining an edge pointing to a root element;
invoking a recursive function to build up document fragments rooted at a specific element, said recursive function including the further steps of
tagging said element;
producing character values associated with said element;
determining edges pointing to attributes of said element using a nested sub-query;
creating said attributes using an XQuery built-in function attribute;
determining edges pointing to a sub-element of said element using another nested sub-query and recursively invoking said recursive function for each said sub-element;
ordering said sub-elements.

7. A computer program product for querying XML documents in a relational database system, comprising a computer readable storage medium having computer readable program means embodied in said medium, said computer readable program means comprising:
computer readable program means for creating an XML document view;
computer readable program means for creating relational tables for storing XML documents using relational schema;
computer readable program means for shredding said XML documents and storing said XML documents as rows in said relational tables according to said relational schema;
computer readable program means for generating a reconstruction view over said relational tables to define how said shredded XML documents are to be virtually reconstructed; and
computer readable program means for processing queries over said stored XML documents as queries over said reconstruction view.

8. The computer program product of claim 7, wherein said relational schema may be generated by any number of generation methods, including those methods using a DTD, those methods using XML Schema, those methods ignoring any DTD, and those methods ignoring any XML Schema.

9. The computer program product of claim 6, wherein said computer readable program means for processing queries processes queries over at least one of: said XML documents, relational data, XML views of said relational data.

10. The computer program product of claim 7 wherein a DTD is provided, further comprising:
computer readable program means for recursively traversing a DTD graph for relational schema generation;
computer readable program means for binding variables to said rows using an XQuery “For” clause;
computer readable program means for creating XML element tags;
computer readable program means for recursively invoking the above steps on child attributes and operator nodes and sub-element nodes to create XQuery fragments to reconstruct said nodes.

11. The computer program product of claim 10, further comprising:
computer readable program means for relating said sub-element nodes to respective parent nodes by a join;
computer readable program means for ordering said sub-element nodes in the same way as said sub-element nodes appear in said XML documents using a sortby clause.

12. The computer program product of claim 7, wherein XML schema information is not used, further comprising:
computer readable program means for determining an edge pointing to a root element;
computer readable program means for invoking a recursive function to build up document fragments rooted at a specific element, said recursive function including
computer readable program means for tagging said element;
computer readable program means for producing character values associated with said element;
computer readable program means for determining edges pointing to attributes of said element using a nested sub-query;
computer readable program means for creating said attributes using an XQuery built-in function attribute;
computer readable program means for determining edges pointing to a sub-element of said element using another nested sub-query and recursively invoking said recursive function for each said sub-element;
computer readable program means for ordering said sub-elements.

13. A general purpose computer including a data storage device with a computer usable medium having computer readable program means for querying XML documents in a relational database system, comprising:
computer readable program means for creating an XML document view;
computer readable program means for creating relational tables for storing XML documents using relational schema;
computer readable program means for shredding said XML documents and storing said XML documents as rows in said relational tables according to said relational schema;
computer readable program means for generating a reconstruction view over said relational tables to define how said shredded XML documents are to be virtually reconstructed; and
computer readable program means for processing queries over said stored XML documents as queries over said reconstruction view.

14. The computer of claim 13 wherein said relational schema may be generated by any number of generation methods, including those methods using a DTD, those methods using XML Schema, those methods ignoring any DTD, and those methods ignoring any XML Schema.

15. The computer of claim 13 wherein said computer readable program means for processing queries processes queries over at least one of said XML documents, relational data, XML views of said relational data.

16. The computer of claim 13 wherein a DTD is provided, further comprising:
computer readable program means for recursively traversing a DTD graph for relational schema generation;
computer readable program means for binding variables to said rows using an XQuery “For” clause;
computer readable program means for creating XML element tags;
computer readable program means for recursively invoking the above steps on child attributes and operator nodes and sub-element nodes to create XQuery fragments to reconstruct said nodes.

17. The computer of claim 16 further comprising:
computer readable program means for relating said sub-element nodes to respective parent nodes by a join;
computer readable program means for ordering said sub-element nodes in the same way as said sub-element nodes appear in said XML documents using a sortby clause.

18. The computer of claim 13 wherein XML schema information is not used, further comprising:
computer readable program means for determining an edge pointing to a root element;
computer readable program means for invoking a recursive function to build up document fragments rooted at a specific element, said recursive function including
computer readable program means for tagging said element;
computer readable program means for producing character values associated with said element;
computer readable program means for determining edges pointing to attributes of said element using a nested sub-query;
computer readable program means for creating said attributes using an XQuery built-in function attribute;
computer readable program means for determining edges pointing to a sub-element of said element using another nested sub-query and recursively invoking said recursive function for each said sub-element;
computer readable program means for ordering said sub-elements.

19. A system for querying XML documents in a relational database system, comprising:
means for creating an XML document view;
means for creating relational tables for storing XML documents using relational schema;
means for shredding said XML documents and storing said XML documents as rows in said relational tables according to said relational schema;
means for generating a reconstruction view over said relational tables to define how said shredded XML documents are to be virtually reconstructed; and
means for processing queries over said stored XML documents as queries over said reconstruction view.
